(19) United States
(12) Patent Application Publication
(10) Pub. No.: US 2025/0030057 A1
(43) Pub. Date: Jan. 23, 2025

(54) METHOD OF MAKING A COMPONENT FOR A SOLID-STATE ELECTROCHEMICAL CELL

(71) Applicant: Dyson Technology Limited, Malmesbury, Wiltshire (GB)

(72) Inventor: Samuel James CHAPMAN, Gloucester (GB)

(21) Appl. No.: 18/714,694

(22) PCT Filed: Dec. 2, 2022
(86) PCT No.: PCT/GB2022/053062

§ 371 Date: May 30, 2024

(30) Foreign Application Priority Data
Dec. 6, 2021 (GB) 2117569.0

(51) Int. Cl. H01M 10/0585; B23K 26/362; B23K 26/402; B23K 101/36; B23K 103/00; H01M 10/0562

(52) U.S. Cl. CPC H01M 10/0585; B23K 26/362; B23K 26/402; H01M 10/0562; B23K 2101/36; B23K 2103/50; H01M 2300/0068

(57) ABSTRACT

Methods of making components for solid-state electrochemical cells are disclosed. In examples, the component comprises an electrode layer and an electrolyte layer, and the method: providing a substrate; depositing an electrolyte material on a first surface of the substrate to form an electrolyte layer on the substrate, wherein a first surface of the electrolyte layer contacts the first surface of the substrate along an interface; depositing an electrode material on a second surface of the electrolyte layer to form an electrode layer on the electrolyte layer, the second surface of the electrolyte layer being opposed to the first surface of the electrolyte layer; and separating the electrolyte layer from the substrate along the interface. Also described herein are methods of methods of providing solid-state electrochemical cells, solid-state electrochemical cells, battery stacks, and electrically-powered devices.

### TECHNICAL FIELD

The present invention relates to methods of making components for solid-state electrochemical cells, methods of making solid-state electrochemical cells, solid-state electrochemical cells, battery stacks, and electrically-powered devices.

### BACKGROUND

Manufacturing solid-state secondary (rechargeable) electrochemical cells is a complex and, to date, expensive process. Manufacturing solid-state secondary electrochemical cells typically involves depositing very thin layers of active materials sequentially on top of each other. However, this deposition process is often time consuming, and often requires specialised equipment and/or conditions. For example, the deposition may have to be performed in high vacuum, inert, or tightly humidity-controlled atmospheres during manufacture of the solid-state electrochemical cell.

Solid-state electrochemical cells typically include at least one electrode layer contacting (e.g. abutting) a separator layer, such as an electrolyte layer. The degree to which these layers contact, e.g. the proportion of a surface of an electrode which contacts a surface of the electrolyte layer, is typically referred to as the degree of interfacial contact. The degree of interfacial contact between the electrode layer and the electrolyte layer can affect the performance of the cell. For example, reduced interfacial contact between the electrolyte layer and the electrode layer can result in shorting of the solid-state electrochemical cell, premature cell degradation, a reduced cell capacity, or increased resistance across the cell.

Interfacial contact between an electrode and an electrolyte in a secondary (e.g. rechargeable) solid-state electrochemical cell in some cases reduces over time (e.g. the electrolyte delaminates from the electrode over time) due to cycling of the cell, which is often associated with volumetric expansion and contraction.

### SUMMARY

In examples of a first aspect of the present disclosure there is provided a method of making a component for a solid-state electrochemical cell. The component comprises an electrode layer and an electrolyte layer. The method comprises providing a substrate; depositing an electrolyte material on a first surface of the substrate to form an electrolyte layer on the substrate, wherein a first surface of the electrolyte layer contacts the first surface of the substrate along an interface; depositing an electrode material on a second surface of the electrolyte layer to form an electrode layer on the electrolyte layer, the second surface of the electrolyte layer being opposed to the first surface of the electrolyte layer; and separating the electrolyte layer from the substrate along the interface.

Surprisingly, the inventor has identified that examples of forming an electrolyte layer on a substrate and subsequently separating the electrolyte layer from the substrate provides a component comprising an electrode layer having a high electrode density. Moreover, in examples the method provides a component which can be used in the manufacture of a solid-state electrochemical cell wherein the electrolyte layer has improved interfacial contact with a further electrode at the first surface of the electrolyte layer.

Further, the inventor has advantageously identified that forming an electrolyte layer on a substrate and subsequently separating the electrolyte layer from the substrate allows for the provision of thinner electrolyte layers in components for solid-state electrochemical cells, which in turn allows for thinner solid-state electrochemical cells.

Further still, in examples, a thinner electrolyte reduces ionic resistance across the solid-state electrochemical cell (when the component is provided as part of a solid-state electrochemical cell), thereby improving the ionic conductance across the solid-state electrochemical cell and thus the efficiency of the solid-state electrochemical cell.

The depositing the electrode material on the second surface of the electrolyte layer forms an electrode layer on the electrolyte layer. Typically, the electrode layer abuts the first surface of the electrolyte, e.g. is the electrode contacts the first surface of the electrolyte.

At least the first surface of the substrate is typically smooth, e.g. has a low surface roughness. In examples, the first surface of the substrate has a surface roughness of Xs, where Xs≤500 nm, or ≤100 nm. In examples, Xs is greater than or equal to 1 nm, for example greater than of equal to 5 nm.

In examples, the surface roughness is measured by a profilometer. Typically, the surface roughness is measured by means of calculating the RMS roughness. The RMS roughness is calculated as the deviation in height from a perfectly smooth external surface. It will be understood that a perfectly smooth external surface is perfectly flat when the mid-plane of the substrate is transformed onto a flat plane. The surface roughness may be measured by means of calculating the arithmetic average of the absolute values of profile heights (above the minimum height measured) over an evaluation length of a sample.

The inventor has also identified that, advantageously, forming the electrolyte on a substrate having a smooth surface in turn provides an electrolyte having a surface with low surface roughness. In examples, the component is further processed to provide a solid-state electrochemical cell, as described hereinbelow. The electrolyte having a low surface roughness provided by examples of the above-described method typically provides for improved interfacial contact between the electrolyte and the second electrode, thereby reducing the likelihood of delamination between the electrolyte and the electrode. The risk of coating defects (i.e. pin holes) may also be mitigated. This typically results in a cell with improved conductivity and lifespan.

In examples, at least one of the electrolyte and the electrode is substantially opaque to electromagnetic radiation in the visible region. For example, at least one of the electrolyte and the electrode substantially does not transmit electromagnetic radiation in the visible range. In examples, the electrolyte and/or the electrode have a transmissivity (t) of less than 0.1, or less than 0.01, wherein the transmissivity (t) is defined as:

$$τ = \frac{t r a n s m itted radiation}{i n c ident radiation}$$

In examples, the separating the electrolyte layer from the substrate comprises irradiating the substrate and/or electrolyte layer with electromagnetic radiation. In examples, the separating the electrolyte layer from the substrate comprises irradiating the substrate and/or electrolyte layer with electromagnetic radiation, thereby ablating at least a portion of the electrolyte layer and/or the substrate at the interface.

Ablation as used herein is the removal of material. In examples, ablating comprises melting and/or evaporation of material.

In examples, the portion of electrolyte layer and/or the substrate which is to be ablated is absorptive of the electromagnetic radiation. For example, irradiating the portion with electromagnetic radiation transfers energy to the portion, thereby ablating the portion.

In examples, the electromagnetic radiation is generated by a device for providing electromagnetic radiation. In examples, the device generates electromagnetic radiation across a range of wavelengths; in other examples, the device generates electromagnetic radiation of substantially the same wavelength.

In examples, the device for providing electromagnetic radiation is a laser; the electromagnetic radiation which irradiates the substrate and/or electrolyte layer is generated by a laser. Advantageously, a laser can be used to provide electromagnetic radiation of a specific wavelength, e.g. a wavelength at which a portion of the electrolyte layer and/or substrate is absorptive. Further, a laser can be used to selectively irradiate desired portions of the electrolyte layer and/or substrate.

In other examples, the device for providing electromagnetic radiation is a flash lamp; the electromagnetic radiation which irradiates the substrate and/or electrolyte layer is generated with a flash lamp. For example, the flash lamp generates a burst of electromagnetic radiation (e.g. a pulse of electromagnetic radiation supplied to the electrolyte layer and/or substrate over a short period of time), thereby irradiating the electrolyte layer and/or substrate.

In examples, the electromagnetic radiation is incident on a second surface of the substrate, the second surface being opposed to the first surface of the substrate. For example, the electromagnetic radiation is supplied to the second surface of the substrate, and at least a portion of the electromagnetic radiation passes through the thickness of the substrate to irradiate the portion of electrolyte layer and/or the portion of substrate at the interface.

In examples, the substrate is a laminate comprising a first layer along the first surface and a second layer along the second surface, at least the second layer having a transmissivity of at least 0.9 for the electromagnetic radiation.

In examples, the second layer is substantially translucent or transparent to the electromagnetic radiation. Accordingly, the electromagnetic radiation passes through the second layer without substantial attenuation.

In examples, the first layer of the substrate is at least partially absorptive of the electromagnetic radiation.

In examples, the first layer of the substrate is at least partially absorptive of the electromagnetic radiation, such that the irradiating heats at least a portion of the first layer of the substrate. In examples, the heating results in thermal expansion and/or modification of shear stress properties of a portion of the first layer substrate at the interface between the substrate and electrolyte layer, thereby separating the substrate and the electrolyte layer.

In examples, the first layer of the substrate is at least partially absorptive of the electromagnetic radiation, such that the irradiating ablates at least a portion of the first layer of the substrate. In examples, the irradiation ablates at least a portion of the first layer at the interface between the substrate and electrolyte layer, thereby separating the substrate and the electrolyte layer.

Advantageously, these examples typically result in little, or no, ablation of the electrolyte layer of electrode layer during the separation, such that valuable solid-state electrochemical cell material is not removed from the component. Further, there is little, or no, contamination of the first surface of the electrolyte layer and/or the first surface of the substrate after separation of the electrolyte layer and the substrate. Therefore, the component for the solid-state electrochemical cell can be taken forward in a process of manufacturing a solid-state electrochemical cell without cleaning or modification of the first surface before providing a second electrode on the first surface of the electrolyte layer. Similarly, the substrate can be re-used in another component-formation method without cleaning or modification of the first surface of the substrate before carrying out the component-formation method.

In examples, the first layer of the substrate comprises a polymer material which is absorptive of the electromagnetic radiation which irradiates the substrate, such that the irradiation ablates at least a portion of the first layer at the interface between the substrate and electrolyte layer, thereby separating the substrate and the electrolyte layer.

In examples, the first layer of the substrate comprises metal which is absorptive of the electromagnetic radiation which irradiates the substrate, such that the irradiation heats at least a portion of the first layer at the interface between the substrate and electrolyte layer, thereby expanding the portion of the first layer and/or modifying the shear stress properties of the portion of the first layer and separating the substrate and the electrolyte layer. In examples, the first layer of the substrate comprises tungsten.

The deposition of the electrode material and/or the deposition of the electrolyte material is performed using any suitable deposition process.

In examples, the deposition comprises physical vapour deposition. Physical vapour deposition (PVD) is an example of vacuum deposition and refers to a process wherein a condensed material is vaporised, and then at least some of the vaporised material condenses on a substrate to provide a condensed layer. Examples of PVD include thermal deposition (also referred to as evaporative deposition), and sputtering.

In examples, the depositing comprises chemical vapour deposition. Chemical vapour deposition (CVD) is an example of vacuum deposition and refers to a process wherein a substrate is exposed to one or more volatile precursors, which react and/or decompose on the substrate surface to produce a layer. Examples of CVD include low pressure chemical vapour deposition (LPCVD) and plasma enhanced chemical vapour deposition (PECVD).

In examples, the depositing comprises aerosol deposition. Aerosol deposition is a process wherein solid particulate matter (e.g. powder) is accelerated towards a substrate dispersed in a carrier gas as an aerosol, thereby bombarding a surface of the substrate with the solid particulate matter to produce a layer. Suitably, aerosol deposition can be carried out at atmospheric pressure or under a coarse vacuum (e.g. 1×10⁵ to 3×10³ Pa), and at room temperature.

In examples, the depositing comprises electrophoretic depositing. Electrophoretic deposition refers to a process wherein colloidal particles suspended in a liquid medium migrate under the influence of an electric field (electrophoresis) and are deposited onto a substrate. Examples of electrophoretic deposition include electrocoating, electrodeposition, and electrophoretic coating, and electrophoretic painting.

In examples, the depositing comprises casting. Examples of casting include spray casting, sheet casting, and spin casting. In examples, the depositing comprises screen printing.

In particular examples, the depositing the electrolyte material comprises physical vapour deposition. For example, the depositing the electrolyte material on the first surface of the substrate comprises physical vapour deposition of electrolyte material on at least a portion of the first surface of the substrate, thereby providing an electrolyte layer coating at least part of the first surface of the substrate.

In particular examples, the depositing the electrode material comprises aerosol deposition. For example, the depositing the electrode material on the second surface of the electrolyte layer comprises aerosol deposition of electrode material on at least a portion of the second surface of the electrolyte layer, thereby providing an electrode layer coating at least part of the second surface of the electrolyte layer.

Advantageously, the inventor has identified that aerosol deposition of the electrode material can allow for quicker formation of an electrode layer. For example sublayers of electrode material (e.g. sublayers which correspond to a portion of the thickness of the final electrode layer and together form the total electrode layer) are formed on the electrolyte layer more quickly (e.g. in the order of micrometres per minute) than some other deposition methods (e.g. in the order of micrometres per hour). Further, the deposition can be performed under less demanding conditions. For example, the aerosol deposition can be performed under a coarse vacuum (e.g. 1×10⁵ to 3×10³ Pa) or under atmospheric conditions, compared with some other deposition methods which require medium or high vacuum, and at a lower temperature (e.g. 20° C.) compared with some other deposition methods which require higher temperatures (e.g. 500° C. or higher). Further still, examples of aerosol deposition obviate the need for complex equipment and processing associated with some other deposition methods. For example, examples of aerosol deposition obviate the need for the generation of complex magnetic fields during the deposition process, and conventional electrode powders (e.g. conventional cathode powders) can be used as the feedstock electrode material.

In examples the electrode layer is a cathode layer, or an anode layer. In examples, the electrode material comprises one or more metal oxides.

Where the electrode layer is a cathode layer, the electrode material comprises cathode material. In examples, the cathode material comprises, consists essentially of, or consists of: lithium nickel manganese oxide (LiNi_{0.5}Mn_{1.5}O₄), typically referred to as LNMO; lithium cobalt oxide (LiCoO₂), typically referred to as LCO; lithium manganese oxide (LiMn₂O₄), typically referred to as LMO; lithium titanate (Li₄Ti₅O₁₂), typically referred to as LTO); lithium nickel manganese cobalt oxide (LiNi_{1-x-y}MnₓCo_{y}O₂), typically referred to as NMC; lithium iron phosphate (LiFePO₄), typically referred to as LFP, lithium nickel cobalt aluminium oxide (LiNi_{1-x-y}CoₓAl_{y}O₂), typically referred to as NCA; lithium sulfide (Li₂S); silver vanadium oxide (AgV₂O_{5.5}), typically referred to as SVO; or combinations thereof. In examples, the cathode is a ceramic, e.g. comprises ceramic material. In examples, the cathode material comprises, consists essentially of, or consists of, one or more metal oxides. In particular examples, the cathode material comprises, consists essentially of, or consists of LCO.

Where the electrode layer is an anode layer, the electrode comprises anode material. In examples, the anode material comprises, consists essentially of, or consists of: silicon, carbon, indium tin oxide (ITO), molybdenum dioxide (MoO₂), lithium titanate (Li₄Ti₅O₁₂—typically referred to as LTO), lithium alloy, metallic lithium, or combinations thereof. Where the anode comprises carbon, the anode comprises any suitable carbon-based material. For example, the anode comprises graphite, graphene, hard carbon, activated carbon, and/or carbon black. In particular examples, the anode material comprises, consists essentially of, or consists of metallic lithium.

The electrolyte comprises electrolyte material, typically ceramic electrolyte material. In examples, the electrolyte material comprises, consists essentially of, or consists of: perovskite-type Li-ion conductor; anti-perovskite-type Li-ion conductor; garnet-type Li-ion conductor; sodium super ionic Li-ion conductor (NASICON); NASICON-related Li-ion conductor; lithium super ionic conductor (LISICON); LISICON-related Li-ion conductor; thio-LISICON; thio-LISICON-related Li-ion conductor; lithium phosphorous oxy-nitride (LiPON); lithium aluminium titanium phosphate (Li_{1.3}Al_{0.3}Ti_{1.7}(PO₄)₃, typically referred to as LATP); related amorphous glassy type Li-ion conductors, or combinations thereof.

In examples, the electrolyte material comprises lithium phosphorous oxy-nitride (LiPON). In particular examples, the electrolyte material comprises LiPON having the following formula: LiₓPO_{y}N_{z} where x=2y+3z−5, and x<4. In examples, the electrolyte comprises at least 50 wt %, 80 wt %, 90 wt %, 95 wt % or 99 wt % LiPON by dry weight of the electrolyte. In some examples, the electrolyte consists essentially of, or consists of, LiPON.

In examples, the electrode material is a cathode material comprising, consisting essentially of, or consisting of LCO, and the electrolyte material comprises, consists essentially of, or consists of LiPON.

In examples, the electrode layer (e.g. cathode layer or anode layer) further comprises electrolyte material. For example, the electrode is a cathode, and the cathode comprises cathode material and electrolyte material. Alternatively, the electrode is an anode, and the anode comprises anode material and electrolyte material.

For example, electrolyte material is dispersed along a thickness of the cathode layer. A portion of cathode layer comprises electrolyte material dispersed along a thickness of that portion. Typically, the electrolyte material is also dispersed along the width and length of the portion of cathode layer.

Advantageously, the inventor has identified that an electrode layer at least partly comprising electrolyte material improves conductivity through the component for a solid-state electrochemical cell. Accordingly, an electrode layer comprising electrolyte material can be provided with a greater thickness while avoiding a reduction in conductivity deriving from the increased thickness.

In examples, the electrode layer comprises approximately 1% to 30% electrolyte material by dry weight of the electrode layer, or 10 to 20%.

The electrolyte-material-containing electrode layer is arranged on the electrolyte layer (e.g. a layer comprising, consisting essentially of, or consisting of electrolyte material) in the component for a solid-state electrochemical cell. That is, the presence of electrolyte material in the electrode layer does not obviate the need for the electrolyte layer which is arranged between the substrate and electrode layer during manufacture.

The electrode and the electrolyte of the solid-state electrochemical cell component are provided as layers. A layer extends in a first dimension (thickness), second dimension (length), and third dimension (width). Typically, the thickness of a layer is its smallest dimension and the length of the layer is its greatest dimension, although this is not necessarily the case. In examples, the first dimension of the layers (e.g. the thicknesses) extend in the direction that the electrode and electrolyte are stacked in the solid-state electrochemical cell component. “Thickness” may refer to the overall thickness of a layer, or the thickness (e.g. extent in a first dimension) of a portion of a layer.

As noted above, the inventors have identified that examples of the method described hereinabove can provide electrolyte layers have a smaller thickness than other methods.

In examples, the electrolyte layer has a thickness of less than 10 μm.

In examples, the method further comprises providing a current collector on a second surface of the electrode layer, the second surface of the electrode layer being opposed to the first surface of the electrode and the electrolyte. In examples, the providing the current collector is performed before the separation of the electrolyte layer from the substrate. In these examples, the component for a solid-state electrochemical cell comprises an electrolyte layer, an electrode layer, and a current collector layer.

In examples, the current collector is a metal layer (e.g. comprising metallic copper, tungsten, platinum, nickel, stainless steel) such as metal foil, a metal screen, a metal film on a polymer film or sufficiently conductive SiO₂ layer, or any other known substrate or barrier layer.

In examples, the current collector is a metal layer comprising tungsten (W) or platinum (Pt). In particular examples, the electrode layer is a cathode layer, and the current collector comprises is a metal layer comprising platinum.

The current collector has a suitable thickness. In examples, the current collector has a thickness of from 10 nm to 20 μm. In examples, the current collector has a thickness of approximately from 50 nm to 100 nm, or 50 nm, or 100 nm.

In examples, the providing the current collector comprises applying a current collector layer comprising current collector material to the second surface of the electrode layer. For example, a metal foil is placed on the second surface of the electrode layer. In examples, the metal foil is adhered to the surface of the electrode layer.

In examples, the providing the current collector comprises metalizing at least a portion of the second surface of the electrode layer. For example, at least a portion of the second surface of the electrode layer is coated with metal. In examples, the providing the current collector comprises vacuum metallizing the second surface of the electrode layer, thermal spraying a composition comprising metal on the second surface of the electrode layer, or cold spraying a composition comprising metal on the second surface of the electrode layer.

In examples, the substrate comprises silica, silicon, and/or alumina. For example, the substrate comprises, consists essentially of, or consists of glass, quartz, and/or sapphire.

In examples, the substrate comprises a first layer and a second layer, and the second layer comprises, consists essentially of, or consists of glass, quartz, and/or sapphire. As described above, in some examples at least a portion of the substrate (e.g. a portion extending along part of the thickness of the substrate, such as the second layer) is substantially translucent or transparent to the electromagnetic radiation used to separate the electrolyte layer from the substrate. In other examples, the substrate is substantially translucent or transparent to the electromagnetic radiation along the entire thickness of the substrate. In these examples, substantially all of the electromagnetic radiation incident on the second surface of the substrate is transmitted to the first surface of the electrolyte layer during the separation.

In examples, after the separating the electrolyte layer from the substrate, the substrate is reused in a method of making a further component for a solid-state electrochemical cell. Advantageously, after preparing the component and separating the component from the substrate, the substrate can be reused in the manufacture of further components. That is, after the separating the electrolyte layer from the substrate in a first instance of the manufacturing process described hereinabove, electrolyte material is deposited on the first surface of the substrate as part of a second instance of the manufacturing process described hereinabove. In some examples, the substrate can be reused in the manufacture of further components without performing any cleaning or surface-modifying processes after separating the substrate from the electrolyte layer in a first instance of the manufacturing process and depositing electrolyte material on the surface of the substrate in the a second instance of the manufacturing process.

In examples of a second aspect of the present disclosure there is provided a method of making a solid-state electrochemical cell. The method comprises providing a substrate; depositing an electrolyte material on a first surface of the substrate to form an electrolyte layer on the substrate, wherein a first surface of the electrolyte layer contacts the first surface of the substrate along an interface; depositing a first electrode material on a second surface of the electrolyte layer to form a first electrode layer on the electrolyte layer, the second surface of the electrolyte layer being opposed to the first surface of the electrolyte layer; separating the electrolyte layer from the substrate along the interface, thereby exposing the first surface of the electrolyte layer; depositing a second electrode material on the first surface of the electrolyte layer to form a second electrode layer on the electrolyte layer; providing a first current collector on the first electrode, the first current collector being opposed to the electrolyte, the first current collector comprising a first current collector material; and providing a second current collector on the second electrode, the second current collector opposed to the electrolyte, the second current collector comprising a second current collector material, to afford the solid-state electrochemical cell.

In examples, the first electrode is a cathode, the first electrode material is cathode material, the second electrode is an anode, and the second electrode material is anode material. In these examples, the method comprises providing a substrate; depositing an electrolyte material on a first surface of the substrate to form an electrolyte layer on the substrate, wherein a first surface of the electrolyte layer contacts the first surface of the substrate along an interface; depositing a cathode material on a second surface of the electrolyte layer to form a cathode layer on the electrolyte layer, the second surface of the electrolyte layer being opposed to the first surface of the electrolyte layer; separating the electrolyte layer from the substrate along the interface, thereby exposing the first surface of the electrolyte layer; depositing an anode material on the first surface of the electrolyte layer to form an anode layer on the electrolyte layer; providing a cathode collector on the cathode layer, the cathode current collector being opposed to the electrolyte, the cathode current collector comprising a cathode current collector material; and providing an anode current collector on the anode layer, the anode current collector opposed to the electrolyte, the anode current collector comprising an anode current collector material.

In examples, the providing the substrate, the depositing the electrolyte material, the depositing the first electrode material, and the separating the electrolyte layer from the substrate corresponds to the method according to the first aspect. Features described in relation to the first aspect are explicitly disclosed in combination with the second aspect, to the extent that they are compatible.

The depositing the anode material on the first surface of the electrolyte layer to form the anode layer is performed according to any of the deposition processes described hereinabove. In particular examples, the depositing the anode material comprises physical vapour deposition. For example, the depositing the anode material on the first surface of the electrolyte layer comprises physical vapour deposition of anode material on at least a portion of the first surface of the electrolyte layer, thereby providing an anode layer coating at least part of the first surface of the electrolyte layer.

In examples, the depositing the electrolyte material comprises physical vapour deposition, the depositing the cathode material comprises aerosol deposition, and the deposition the anode material comprises physical vapour deposition.

In examples, the cathode material comprises, consists essentially of, or consists of NMC, the electrolyte material comprises, consists essentially of, or consists of LiPON, and the anode material comprises, consists essentially of, or consists of metallic lithium.

In examples, the anode layer (e.g. metallic lithium) has a thickness of less than 20 μm, or 15 μm. The inventors have identified that, in some cases, anodes having a thickness greater than 20 μm are more prone to cracking, thereby reducing longevity of the electrochemical cell.

In examples, each current collector (the anode current collector and cathode current collector) is a metal layer (e.g. comprising metallic copper, tungsten, platinum, nickel, stainless steel) such as a metal foil, a metal screen, a metal film on a polymer film or sufficiently conductive SiO₂ layer, or any other known substrate or barrier layer.

In examples, the anode current collector is a tungsten (W) layer such as a tungsten foil, and/or the cathode current collector is a platinum (Pt) layer such as a platinum foil.

Each current collector has a suitable thickness. In examples, each current collector has a thickness of from 10 nm to 20 μm. In examples, the anode current collector and/or the cathode current collector have a thickness of approximately from 50 nm to 100 nm, or 50 nm, or 100 nm.

In examples, the providing the current collector (e.g. the anode current collector or the cathode current collector) comprises supplying a current collector layer comprising current collector material to a surface of the electrode. For example, a metal foil is placed on a surface of the electrode layer. In examples, the metal foil is adhered to the surface of the electrode layer.

In examples, the providing the current collector (e.g. the anode current collector or the cathode current collector) comprises metalizing a surface of the electrode. For example, at least a portion of a surface of the electrode layer is coated with metal. In examples, the providing the current collector comprises vacuum metallizing, thermal spraying a composition comprising metal, or cold spraying a composition comprising metal.

In examples, the method further comprises separating a first portion of the solid-state electrochemical cell from a second portion of the solid-state electrochemical cell, thereby providing two solid-state electrochemical cells. For example, the solid-state electrochemical cell obtained from the method can be separated along a plane substantially coplanar with the thicknesses of the layers in the solid-state electrochemical cell, to provide two, separate, solid-state electrochemical cells.

In examples of a third aspect of the present disclosure there is provided a solid-state electrochemical cell obtainable from the method of the second aspect.

The solid-state electrochemical cell is provided in any suitable form. In examples, the solid-state electrochemical cell is a button cell. In examples, the cell has a circular shape along a plane perpendicular to the layers of cathode, electrolyte, and anode forming the cell. In examples, the cell has a diameter of approximately 12 mm.

In examples of a fourth aspect of the present disclosure there is provided a battery stack comprising a plurality of solid-state electrochemical cells according to the third aspect.

The plurality of cells may suitably comprise 2, 3, 4, 5, or more than 5 electrochemical cells. Said battery stack typically comprises a plurality of electrochemical cells as described herein.

In examples, the battery stack is a “back-to-back” stack. For example, the cathodes of two cells are arranged to contact a single current collector. Accordingly, in examples wherein the plurality of electrochemical cells comprises a first solid-state electrochemical cell and a second solid-state electrochemical cell, the cathode current collector of the first cell is also the cathode current collector of the second cell.

In examples of a further aspect of the present disclosure there is provided an electrically-powered device comprising the solid-state electrochemical cell of the third aspect or the battery stack of the fourth aspect. An electrically-powered device is any apparatus which draws electric power from a circuit which includes the cell or battery stack, converting the electric power from the cell or battery stack to other forms of energy such as mechanical work, heat, light, and so on. In examples, the electrically-powered device is a smartphone, a cell phone, a personal digital assistant, a radio player, a music player, a video camera, a tablet computer, a laptop computer, military communications, military lighting, military imaging, a satellite, an aeroplane, a micro air vehicle, a hybrid electric vehicle, a plug-in hybrid electric vehicle, a fully electric vehicle, an electric scooter, an underwater vehicle, a boat, a ship, an electric garden tractor, an unmanned aero drone, an unmanned aeroplane, a remote-controlled car, a robotic toy, a vacuum cleaner such as a robotic vacuum cleaner, a robotic garden tool, a robotic construction utility, a robotic alert system, a robotic aging care unit, a robotic kid care unit, an electric drill, an electric mower, an electric vacuum cleaner, an electric metal working grinder, an electric heat gun, an electric press expansion tool, an electric saw or cutter, an electric sander and polisher, an electric shear and nibbler, an electric router, an electric tooth brush, an electric hair dryer, an electric hand dryer, a global positioning system (GPS) device, a laser rangefinder, a torch (flashlight), an electric street lighting, a standby power supply, uninterrupted power supplies, or another portable or stationary electronic device.

As noted above, features described herein in relation to one aspect of the present disclosure are explicitly disclosed in combination with the other aspects, to the extent that they are compatible.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1A is a schematic flow diagram of a method of making a component for a solid-state electrochemical cell according to examples, depicting cross-sections of features at points in the method; FIG. 1B is a schematic flow diagram of part of the method depicted in FIG. 1A according to some examples; FIG. 1C is a schematic flow diagram of part of the method depicted in FIG. 1A according to other examples.

FIG. 2 is a schematic flow diagram of a method of making a solid-state electrochemical cell according to examples, depicting cross-sections of features at points in the method.

FIG. 3 is a schematic diagram of a cross-section of a solid-state electrochemical cell according to examples.

FIG. 4 is a schematic diagram of a cross-section of a battery stack according to examples.

FIG. 5 is a schematic diagram of an electrically-powered device according to examples.

### DETAILED DESCRIPTION

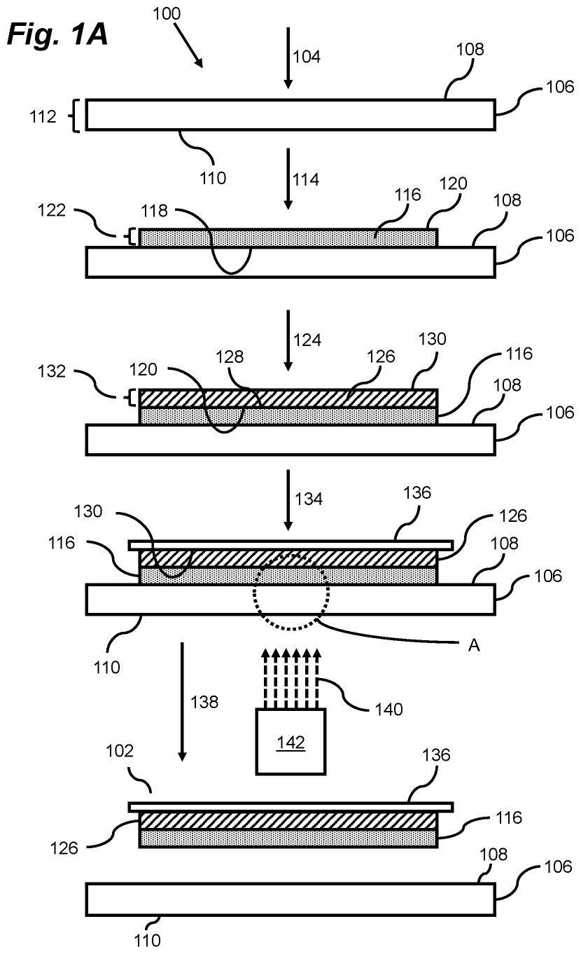

FIG. 1A depicts a method 100 of making a component 102 for a solid-state electrochemical cell according to examples, depicting cross-sections of features at points in the method.

The method 100 comprises providing 104 a substrate 106. In this example, the substrate 106 is a quartz wafer. The substrate 106 has a first surface 108 and a second surface 110. The second surface 110 is opposed to the first surface 108 across the thickness 112 of the substrate 106.

The method 100 further comprises depositing 114 electrolyte material on the first surface 108 of the substrate 106. In this example, the depositing 114 the electrolyte material comprises physical vapour deposition of LiPON on the first surface 108 of the substrate 106. The deposition provides an electrolyte layer 116 on the substrate 106. The electrolyte layer 116 has a first surface 118 and a second surface 120. The second surface 120 is opposed to the first surface 118 across the thickness 122 of the electrolyte layer 116. The first surface 118 of the electrolyte layer 116 contacts the first surface 108 of the substrate. The area of contact between the surfaces (e.g. “faces”) of the electrolyte layer 116 and the substrate 106 is an interface.

The method 100 further comprises depositing 124 electrode material on the second surface 120 of the electrolyte layer 116. In this example, the electrode material is cathode material, and the depositing 124 the electrode material comprises aerosol deposition of LCO on the second surface 120 of the electrolyte layer 116. The deposition provides a cathode layer 126 on the electrolyte layer 116. The cathode layer 126 has a first surface 128 and a second surface 130. The second surface 130 is opposed to the first surface 128 across the thickness 132 of the cathode layer 126. In this example, the first surface 128 of the cathode layer 126 contacts the second surface 120 of the electrolyte layer 116. In other examples (not shown) an intermediate layer separates the cathode layer 126 from the electrolyte layer 116. For example, intermediate layer material is first deposited on the second surface 120 of the electrolyte layer 116 to form an intermediate layer contacting the electrolyte layer 116, and then cathode material is deposited on the intermediate layer to form the cathode layer 126. In this example, although the cathode layer 126 and electrolyte layer 116 are not in direct contact, the cathode layer 126 is nevertheless located adjacent the electrolyte layer 116 and is thus “on” the electrolyte layer. In the example shown, though, the cathode material is deposited such that the cathode layer 126 is in direct contact with the electrolyte layer 116.

The method 100 further comprises providing 134 a current collector 136 on the second surface 130 of the cathode layer 126. In this example, the providing 134 the current collector 136 comprises metallizing the second surface 130 of the cathode layer 126 with platinum to form the cathode current collector 136.

The method 100 further comprises separating 138 the substrate 106 from the electrolyte layer 116. In this example, the separating comprises irradiating the substrate 106 and/or electrolyte layer 116 with electromagnetic radiation 140 generated by a laser 142. The electromagnetic radiation 140 generated by the laser 142 is incident on the second surface 110 of the substrate 106. Further description of the irradiation and the separation of example methods is provided hereinbelow with reference to FIGS. 1B and 1C.

The separating 138 provides the component 102 for a solid-state electrochemical cell, and a separate substrate 106. In this example, the component 102 comprises an electrolyte layer 116, a cathode layer 126, and a cathode current collector 136, the cathode layer 126 sandwiched between the electrolyte layer 116 and the cathode current collector 136. In other examples (not shown), the separating 138 is performed before the application of a current collector such that the component separated from the substrate comprises an electrolyte layer and a cathode layer, but no current collector. In other examples (not shown), the electrode layer is an anode layer such that the component comprises an electrolyte layer, an anode layer, and (optionally) an anode current collector.

In examples, the separating 138 the substrate 106 from the electrolyte layer 116 in a first instance of the method 100 is simultaneously the providing 104 the substrate 106 of a subsequence instance of the method 100. For example, separating the electrolyte layer 116 from the substrate 106 exposes the first surface 108 of the substrate such that the method 100 can be repeated with further electrolyte material being deposited 114 on the first surface 108 of the substrate as a second instance of the method 100.

FIG. 1B is a schematic flow diagram of examples 138a of the separating 138 the electrolyte layer 116 from the substrate 106 according to examples of the method 100. FIG. 1B depicts an enlarged portion of the substrate 106, electrolyte layer 116, and cathode layer 126 corresponding to portion A shown in FIG. 1.

In these examples, the substrate 106 is a laminate comprising a first layer 106a along the first surface 108 of the substrate 106, and a second layer 106b along the second surface 110 of the substrate. The second layer 106b is quartz, and substantially transparent or translucent to the electromagnetic radiation 140 incident on the second surface 110, such that substantially all of the incident electromagnetic radiation 140 is transmitted to the first layer 106a of the substrate.

The first layer 106a is a polymer material which is absorptive for the electromagnetic radiation 140. Thus, electromagnetic radiation 140 transmitted through the second layer 106b is at least partially absorbed by the first layer 106a such that energy is transferred to the first layer 106a. The transfer of energy ablates a portion of the first layer 106a, thereby generating a space 144 (e.g. void) between the electrolyte layer 116 and the second layer 106b of the substrate 106.

Continued irradiation of the first layer 106a results in the ablation of the first layer 106a across the interface between the electrolyte layer 116 and the second layer 106b of the substrate, thereby enlarging the space 144 and separating 138 the electrolyte layer 116 from the substrate 106 (in this case, the electrolyte layer 116 is separated from the second layer 106b of the substrate 106 by ablating the first layer 106a of the substrate). Advantageously, in these examples, substantially no electrolyte material is ablated from the electrolyte layer 116 during the separation 138.

In these examples, to reuse the substrate 106 in a subsequent repetition of the method 100 of making a component for a solid-state electrochemical cell, a coating corresponding to the first layer 106a is applied to the second layer 106b of the substrate to provide a laminate substrate 106 comprising a first layer 106a of substantially absorptive material and a second layer 106b of substantially transmissive material to which electrolyte material can be deposited.

FIG. 1C is a schematic flow diagram of examples 138b of the separating 138 the electrolyte layer 116 from the substrate 106 according to other examples of the method 100. As with FIG. 1B, FIG. 1C depicts an enlarged portion of the substrate 106, electrolyte layer 116, and cathode layer 126 corresponding to portion A shown in FIG. 1.

In these examples, the electrolyte layer 116 can be considered to comprises a first layer 116a along the first surface 118 of the electrolyte layer 116 and a second layer 116b along the second surface 120 of the electrolyte layer 116. In this example, there is no physical separation between the first layer 116a and the second layer 116b. Similarly, there is no difference in composition between the first layer 116a and the second layer 116b. The layers 116a, 116b can therefore be considered to be sublayers.

The substrate 106 is quartz across its entire thickness, and is substantially transparent or translucent to the electromagnetic radiation 140 incident on the second surface 110 of the substrate 106, such that substantially all of the incident electromagnetic radiation 140 is transmitted to the first layer 116a of the electrolyte layer 116.

The electrolyte material of the electrolyte layer 106 is at least partially absorptive for the electromagnetic radiation 140. Thus, electromagnetic radiation 140 transmitted through the substrate 106 is at least partially absorbed by the electrolyte layer 116 such that energy is transferred to the electrolyte layer 116. The transfer of energy ablates a portion of the electrolyte layer 116 along a thickness of the electrolyte layer 116 corresponding to the first layer 116a, thereby generating a space 146 (e.g. void) between the rest of the electrolyte layer 116 corresponding to the second layer 116b and the substrate 106.

Continued irradiation of the electrolyte layer 116 results in the ablation of the first layer 116a of the electrolyte layer 116 across the interface between the electrolyte layer 116 and the substrate 106, thereby enlarging the space 146 and separating 138 the electrolyte layer 116 from the substrate 106 (in this case, the second layer 116b of the electrolyte layer 116 is separated from the substrate 106 by ablating the first layer 116a of the electrolyte layer 116). Advantageously, in these examples, substantially no material is ablated from the substrate 106 during the separation 138, such that the substrate 106 can be reused in further manufacturing methods without any intermediate processes (such as cleaning or applying of cover layers).

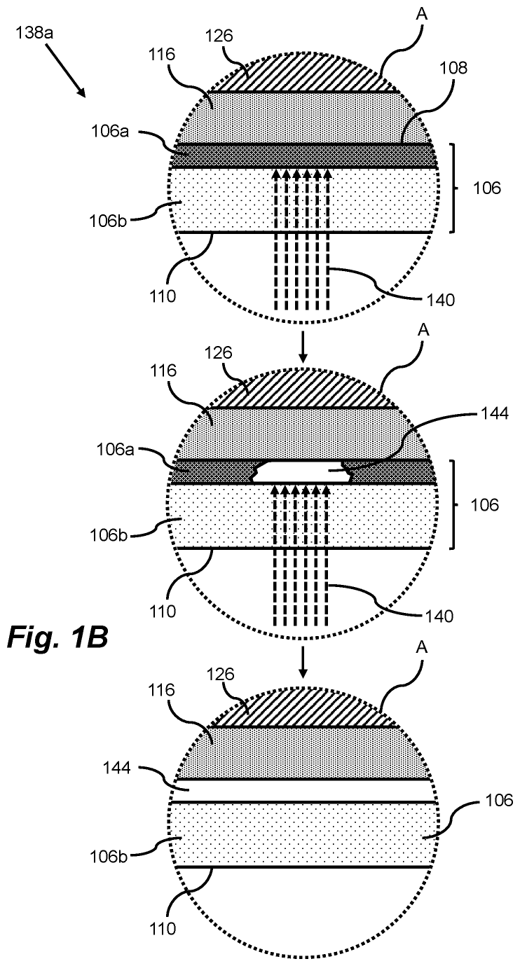

FIG. 2 is a schematic flow diagram of a method 200 of making a solid-state electrochemical cell according to examples, depicting cross-sections of features at points in the method. For reference, features of the method which correspond to features that have already been described in relation to earlier figures are shown with the same reference numeral.

The method 200 comprises providing a component 102 for a solid-state electrochemical cell. In this example, the providing the component 102 for the solid-state electrochemical cell corresponds to the method 100 depicted in FIG. 1A. The component 102 comprises an electrolyte layer 116, a cathode layer 216, and a cathode current collector 136. The first surface 118 of the electrolyte layer 116 is exposed following separation from the substrate 106.

The method 200 comprises depositing 202 anode material on the first surface 118 of the electrolyte layer 116. In this example, the depositing 202 the anode material comprises physical vapour deposition of lithium metal on the first surface 118 of the electrolyte layer 116. The deposition provides an anode layer 204 on the electrolyte layer 116. The anode layer 204 has a first surface 206 and a second surface 208. The second surface 208 is opposed to the first surface across the thickness 210 of the anode layer 204. The first surface 206 of the anode layer 204 contacts the first surface 118 of the electrolyte layer 116.

The method further comprises providing 212 a current collector 214 on the second surface 208 of the anode layer 204. In this example, the providing 212 the current collector 214 comprises metallizing the second surface 208 of the anode layer 204 with tungsten to form the anode current collector 214. Thus, the method 200 provides a solid-state electrochemical cell.

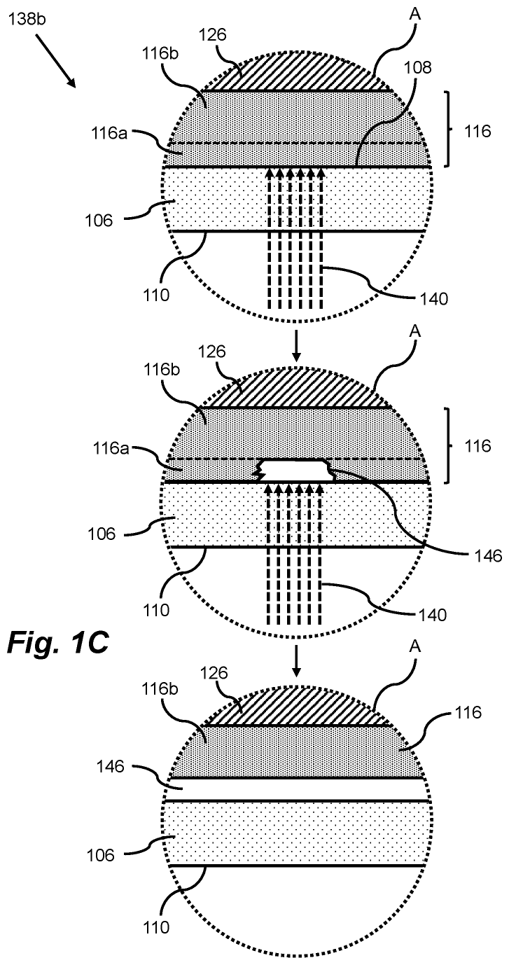

FIG. 3 is a schematic diagram of a cross-section of a solid-state electrochemical cell according to examples. The solid-state electrochemical cell 300 comprises a cathode current collector 302, a cathode layer 304 contacting the cathode current collector 302, an electrolyte layer 306 contacting the cathode layer 304, an anode layer 308 contacting the electrolyte layer 306, and an anode current collector 310 contacting the anode layer 308. In this example, the cathode current collector 302 comprises metallic platinum, the cathode layer 304 comprises LCO, the electrolyte layer 306 comprises LiPON, the anode layer 308 comprises metallic lithium, and the anode current collector 310 comprises metallic tungsten. The solid-state electrochemical cell 300 is, for example, the solid-state electrochemical cell obtained from the method 200 depicted in FIG. 2.

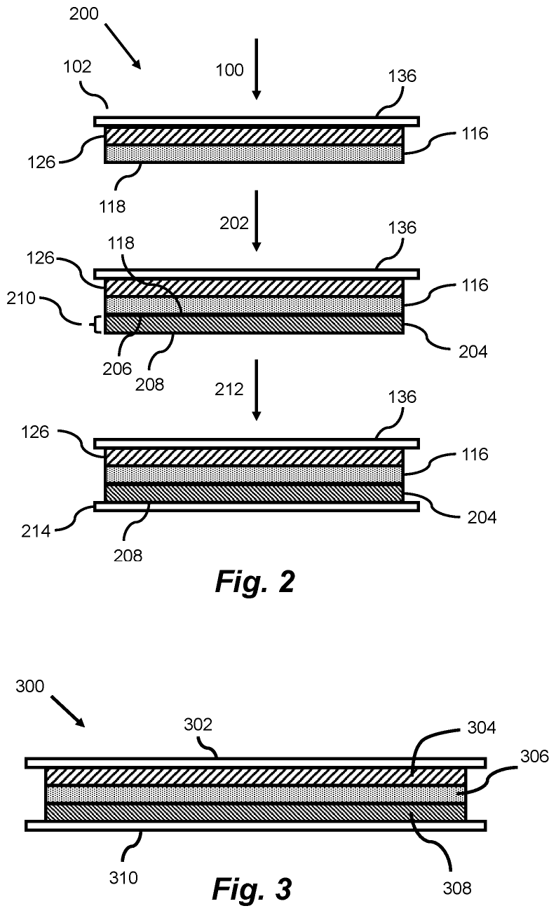

FIG. 4 is a schematic diagram of a cross-section of a battery stack 400 according to examples. The battery stack 400 comprises a plurality of electrochemical cells 300w, 300x, 300y, 300z. As shown in FIG. 4, the plurality comprises a first cell 300w, a second cell 300x, a third cell 300y, and a fourth cell 300z. Other examples of battery stack 400 need only in fact comprise at least two electrochemical cells; the number of cells shown in FIG. 4 is purely exemplary. The description and teaching regarding FIG. 4 is also explicitly disclosed in relation to any battery stack comprising any number of electrochemical cells according to the present disclosure, to the extent that said teaching and said battery stack are technically compatible.

Each cell 300w, 300x, 300y, 300z corresponds to the cell 300 shown in FIG. 3. The components of each cell 300w, 300x, 300y, 300z are labelled using the same numbering used in FIG. 3 to indicate where components are equivalent, appended by “w”, “x”, “y”, or “z” to indicate the cell in which it is comprised.

The battery stack 400 is a “back-to-back” stack, in which every other cell in the stack is reversed so that each current collector has either an anode on each opposing face or a cathode on each opposing face. In particular, in FIG. 4, the anode layer 308w of the first cell 300w and the anode layer 308x of the second cell 300x are arranged on opposite faces of an anode current collector 310w/310x. The anode current collector 310w/310x comprises at least an outer conductive surface and thus is configured to form an electrode on both faces of the anode current collector, e.g. the anode current collector 310w of the first cell 300w and the anode current collector 310x of the second cell 300x. Thus, the anode current collector 310w of the first cell 300w is also the anode current collector 310x of the second cell 300x. The same applies to the anode current collector 310y of the third cell 300w and the anode current collector 310z of the fourth cell 300z mutatis mutandis.

The cathode layer 304x of the second cell 300x and the cathode layer 300y of the third cell 300y are arranged on opposite faces of a cathode current collector 302x/302y. The cathode current collector 302x/302y comprises at least an outer conductive surface and thus is configured to form an electrode on both faces of the cathode current collector, e.g. the cathode current collector 302x of the second cell 300x and the cathode current collector 302y of the third cell 300y. Although not shown in FIG. 4, the same applies to the cathode layer 304w and the cathode current collector 302w of the first cell 300w mutatis mutandis, and to the cathode layer 304z and the cathode current collector 302z of the fourth cell 300z mutatis mutandis, if the battery stack 400 contains further electrochemical cells.

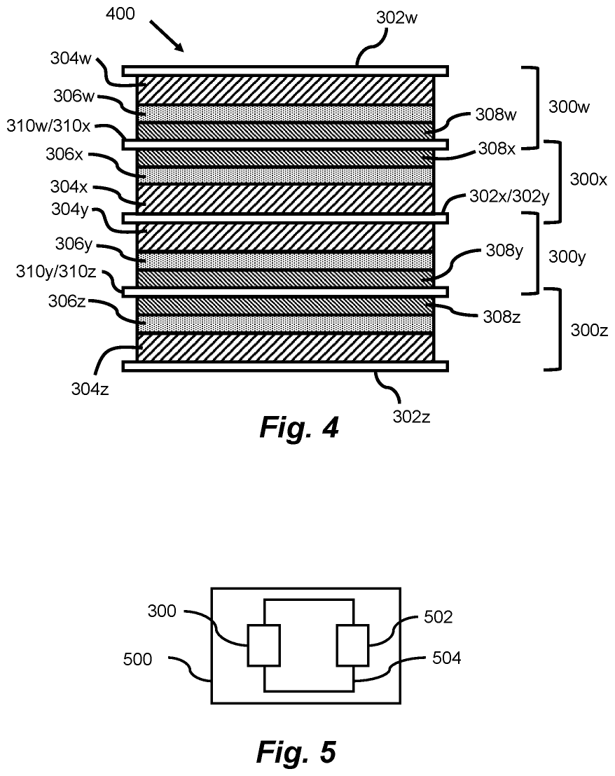

FIG. 5 is a schematic diagram of an electrically-powered device according to examples. The electrically-powered device 500 comprises the solid-state electrochemical cell 300 depicted in FIG. 3. In examples (not shown), the solid-state electrochemical cell 300 is provided as part of a battery stack, such as the battery stack 400 depicted in FIG. 4.

The electrically-powered device comprises an element 502 which converts electric power from the solid-state electrochemical cell 300 to another form of energy (e.g. mechanical work, heat, light, and so on). The solid-state electrochemical cell 300 and element 502 are connected by one or more electrical conduits 504 which, in examples, together form an electrical circuit.

Throughout this specification, reference to an element being “on” another element is to be understood as including direct or indirect contact. In other words, an element on another element may be either touching the other element, or not in contact the other element but, instead, generally supported by an intervening element (or elements) but nevertheless located adjacent, or overlapping, the other element. In some cases, the elements are in contact i.e. in direct contact or abutting. In some cases, the materials may adhere to one another. Where there are a number of stacked materials (such as in the laminate structures described herein), some of the layers may adhere to one another but others need not adhere.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of making a component for a solid-state electrochemical cell, the component comprising an electrode layer and an electrolyte layer, the method comprising:
providing a substrate;
depositing an electrolyte material on a first surface of the substrate to form an electrolyte layer on the substrate, wherein a first surface of the electrolyte layer contacts the first surface of the substrate along an interface;
depositing an electrode material on a second surface of the electrolyte layer to form an electrode layer on the electrolyte layer, the second surface of the electrolyte layer being opposed to the first surface of the electrolyte layer; and
separating the electrolyte layer from the substrate along the interface.

2. The method of claim 1, wherein the separating comprises irradiating the substrate and/or electrolyte layer with electromagnetic radiation, thereby ablating at least a portion of the electrolyte layer and/or the substrate at the interface.

3. The method of claim 2, wherein the electromagnetic radiation is generated by a laser.

4. The method of claim 2, wherein the electromagnetic radiation is incident on a second surface of the substrate, the second surface being opposed to the first surface of the substrate.

5. The method of claim 4, wherein the substrate is a laminate comprising a first layer along the first surface and a second layer along the second surface, at least the second layer having a transmissivity of at least 0.9 for the electromagnetic radiation.

6. The method of claim 5, wherein the first layer of the substrate is at least partially absorptive of the electromagnetic radiation, such that the irradiating ablates at least a portion of the first layer of the substrate.

7. The method of claim 1, wherein the depositing the electrolyte material comprises physical vapour deposition.

8. The method of claim 1, wherein the depositing the electrode material comprises aerosol deposition.

9. The method of claim 1, wherein the electrode material comprises one or more metal oxides.

10. The method of claim 1, wherein the electrolyte material comprises lithium phosphorous oxy-nitride (LiPON).

11. The method of claim 1, wherein the electrolyte layer has a thickness of less than 10 μm.

12. The method of claim 1, wherein the substrate comprises silica, silicon, and/or alumina.

13. The method of claim 1 wherein, after the separating the electrolyte layer from the substrate, the substrate is reused in a method of making a further component for a solid-state electrochemical cell.

14. A method of making a solid-state electrochemical cell, the method comprising:
providing a substrate;
depositing an electrolyte material on a first surface of the substrate to form an electrolyte layer on the substrate, wherein a first surface of the electrolyte layer contacts the first surface of the substrate along an interface;
depositing a first electrode material on a second surface of the electrolyte layer to form a first electrode layer on the electrolyte layer, the second surface of the electrolyte layer being opposed to the first surface of the electrolyte layer;
separating the electrolyte layer from the substrate along the interface, thereby exposing the first surface of the electrolyte layer;
depositing a second electrode material on the first surface of the electrolyte layer to form a second electrode layer on the electrolyte layer;
providing a first current collector on the first electrode, the first current collector being opposed to the electrolyte, the first current collector comprising a first current collector material; and
providing a second current collector on the second electrode, the second current collector opposed to the electrolyte, the second current collector comprising a second current collector material
to afford the solid-state electrochemical cell.

15. The method of claim 14, wherein the first electrode is a cathode, the first electrode material is cathode material, the second electrode is an anode, and the second electrode material is anode material.

16. A solid-state electrochemical cell obtainable obtained from the method of claim 14.

17. A battery stack comprising a plurality of solid-state electrochemical cells according to claim 16.

18. An electrically-powered device comprising the solid-state electrochemical cell of claim 16.
